(19) United States
(12) Patent Application Publication
(10) Pub. No.: US 2005/0087895 A1
(43) Pub. Date: Apr. 28, 2005

(54) Method of creating lenticular material having a selected orientation

(76) Inventor: Joseph D. Franko SR., Ham Lake, MN (US)

Correspondence Address: WALTER K. ROLOFF, 490 HARBOR COURT, SHOREVIEW, MN, 55126, US

(21) Appl. No.: 10/694,417

(22) Filed: Oct. 27, 2003

(51) Int. Cl. B29D 11/00

(52) U.S. Cl. 264/1.6

(57) ABSTRACT

A method of creating lenticular material having a selected orientation includes providing a substantially melted resin to at least one lenticularly patterned surface device and at least one abutting surface device. The abutting surface device selectively abuts the lenticularly patterned surface device. At least one of the abutting surface device and the lenticularly patterned surface device is chilled. The substantially melted resin is directed between the lenticularly patterned surface device and the abutting surface device. The substantially melted resin is thereupon cooled to a substantially solid and optically clear state, and thereby creates at least one lenticule in a resulting web of lenticular material having a selected orientation other than parallel to a machine direction.

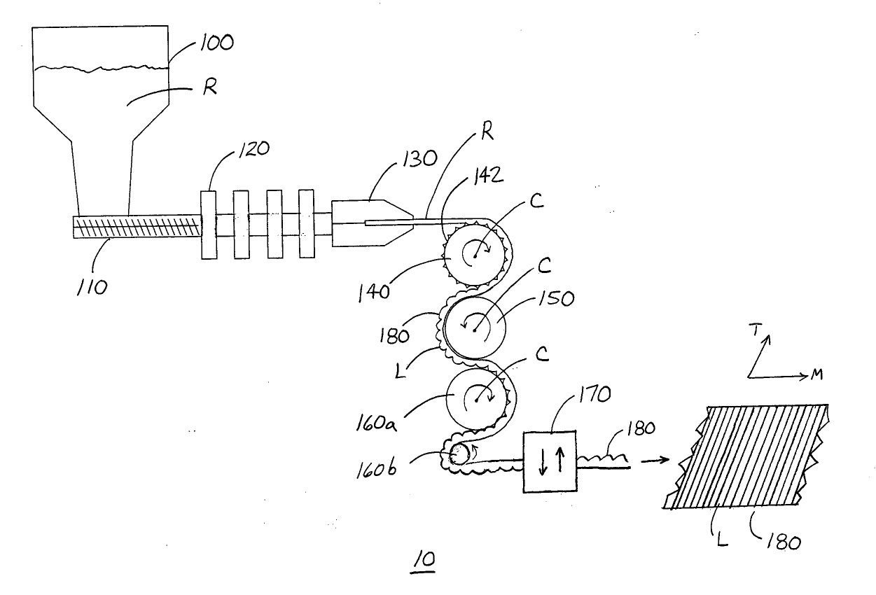

### FIELD OF THE INVENTION

The present invention relates generally to creation of lenticular material. The invention relates specifically to creation of lenticular material having lenticules in a selected orientation, which may be utilized in combination with printed interlaced images to achieve a three-dimensional illusion.

### BACKGROUND OF THE INVENTION

In the printing arts, and in particular in the commercial printed label art for labeling and decorating consumer products, there exists a continual demand for labels and decorations which appeal to consumers; indeed, the commercial success of a given product often relies heavily upon consumer appeal for product packaging and specifically for product decoration and labeling.

Accordingly, manufacturers and retailers have sought marketing strategies for consumer products which exploit the consumer appeal of product labels and decorations (hereinafter, collectively, “labels”). Over the years, labels have evolved from simple printed text descriptions of products, to “eye-catching” multi-color graphics incorporating intricate designs along with product descriptions. Generally, each new label is designed with novelty and brand recognition in mind; label designs tend to be innovative and intriguing to the consumer, in addition to having aesthetic appeal and being identifiable with a particular brand.

It is often desired to impart a special visual effect to a label, such as that of motion or three-dimensionality. Labels having these motion or three-dimensional (“3D”) characteristics are usually considered to be consumer-interactive, for, it is hoped, increased consumer awareness and resulting increased sales of the product so labeled.

In general, motion and 3D visual effects have been costly and difficult to achieve; meanwhile, product manufacturers have demanded that labels be produced for their products as inexpensively as possible, to protect profit margins.

Typically, a pre-formed lenticular material is utilized for production of labels having the motion or 3D effect. Lenticular material, as known in the art, utilizes rows of dome-shaped lenses or “lenticules”, in combination with a lineform or interlaced image, to create a motion or 3D illusion. The lens material is, for the most part, optically clear, and has a flat side and a “lenticulated” side including the lenticules. The lineform or interlaced image comprises image segments oriented into contiguous juxtaposed rows. These image segments are typically created on a base material, such as paper, film, or the like. The image segments are specifically designed to correspond to the lenticules of the lens material, and vice-versa. The flat side of the lens material is secured against the segmented image at an orientation where the lenticules are in alignment with the image segments. When the image is then viewed through the lenticulated side of the lens material, a visual motion or 3D illusion results.

Discussions of fabrication and use of lenticular lens material, and of lineform or interlaced images, are contained within U.S. Pat. Nos. 5,488,451; 5,617,178; 5,847,808; and 5,896,230, each issued to Goggins. Examples of production of motion or 3D visual effect labels are found in U.S. Pat. No. 5,967,032 entitled “PRINTING PROCESS USING A THIN SHEET LENTICULAR LENS MATERIAL” issued to Bravenec, et al; and in U.S. Pat. No. 5,266,995 entitled “METHOD FOR FORMING A GRAPHIC IMAGE WEB” issued to Quadracci, et al. The Quadracci patent discloses the coupling or “marrying” of pre-formed and separately supplied lenticular material with the printed lineform or interlaced image. The Bravenec patent discloses the printing of the image directly onto the flat side of the lenticular material.

It is generally accepted and well-known in the pressure-sensitive label making arts that in-line printing and converting processes may offer the most cost-effective label production, in terms of speed and efficiency. Exemplary in-line methods are disclosed in U.S. Pat. Nos. 5,560,799 and 5,753,344, each entitled “IN-LINE PRINTING PRODUCTION OF THREE DIMENSIONAL IMAGE PRODUCTS INCORPORATING LENTICULAR TRANSPARENT MATERIAL” and issued to Jacobsen. The Jacobsen patents utilize a pre-lenticularized film in an in-line process.

The aforementioned patented processes are predicated upon a supply of a pre-lenticularized, or lenticular, film, having lenticules oriented exclusively parallel to a machine or “web” direction (a direction in which a relatively long sheet or web of material is travelling through an in-line printing and converting press) to create a final “sheeted” lenticular material output (i.e., the final material is cut into sheets). Substantial difficulties may be encountered with reliance upon a supply of such lenticular film to an in-line process for creation of pressure-sensitive labels. Chief among these difficulties is that of lenticular orientation relative to the machine direction. As is well-known in the label making art, the machine direction of an in-line process largely determines the orientation of labels, relative to the machine direction, being produced by the process. In an in-line process using a supply of a pre-lenticularized lens material, consideration must be given to the machine direction because, as aforesaid, the lens material must be correctly aligned with the image.

A web of lenticular labels created in-line according to the aforementioned patented processes results in individual labels that are oriented parallel, rather than perpendicular, to the machine direction. In so-called “wipe-on” label application machines that are particularly suited to high speed container labeling requirements (e.g., 250 to 700 containers/min.) the known in-line produced lenticular labels adhered directly from the machine direction web result in a “sideways” orientation relative to the containers; to correct this condition, the labels must be re-oriented to the containers, which thus makes the process less efficient and more costly.

Furthermore, it is appreciated by those skilled in the art that a lenticular label having its lenticules oriented in a “sideways” sense relative to a container typically will not conform adequately to curved surfaces of the container. Conversely, a label having lenticules oriented with a major axis of the container, in a top-to-bottom sense, will conform quite well to the surfaces of the container. This conformation, or lack thereof, of the lenticular label to the container surface is analogous to a manner in which corrugated cardboard is easily bendable in one orientation (perpendicular to the lengthwise corrugations) but is not readily bendable in an orientation aligned with the corrugations.

To overcome these difficulties, U.S. Pat. Applic. Publ. No. US2003/0012914-A1 entitled “LENTICULAR LABEL MANUFACTURE” suggests providing lenticules which are oriented perpendicular to the machine direction as desired, by way of pre-fabricated lenticular material that is oriented, placed on, and adhesively bonded, to a continuous web. Such manipulations and added manufacturing steps, of course, increase manufacturing costs.

Other exemplary in-line methods of producing lenticular material are disclosed in (i) U.S. Pat. Nos. 5,362,351 and 6,060,003 respectively entitled “METHOD OF MAKING LENTICULAR PLASTICS AND PRODUCTS THEREFROM” and “METHOD AND APPARATUS OF MAKING LENTICULAR PLASTICS”, each issued to Karszes, and (ii) U.S. Pat. No. 6,624,946 entitled “IN-LINE LENTICULAR FILM MANUFACTURING HAVING A SELECTED WEB ORIENTATION”, issued to the present inventor. These patents each require a substrate, belt, or base web upon which to form the lenticular material, which also increases manufacturing costs.

Thus, there exists a need for a low cost, efficient method of creating lenticular material having a selected orientation, and specifically with lenticules that are oriented perpendicular to the machine direction.

### SUMMARY OF THE INVENTION

An object of the present invention is to provide an efficient method of creating lenticular material having a selected orientation.

Another object of the present invention is to provide a method of creating lenticular material wherein lenticules are oriented perpendicular to the machine direction.

In accordance with the present invention, a method of creating lenticular material having a selected orientation includes providing a substantially melted resin to at least one lenticularly patterned surface device and at least one abutting surface device. The abutting surface device selectively abuts the lenticularly patterned surface device. At least one of the abutting surface device and the lenticularly patterned surface device is chilled. The substantially melted resin is directed between the lenticularly patterned surface device and the abutting surface device. The substantially melted resin is thereupon cooled to a substantially solid and optically clear state, and thereby creates at least one lenticule in a resulting web of lenticular material having a selected orientation other than parallel to a machine direction.

### BRIEF DESCRIPTION OF THE DRAWING

The present invention will be further described in connection with the accompanying drawing, which is a schematic diagram of an exemplary and preferred embodiment of a method of creating lenticular material having a selected orientation, in accordance with the present invention.

### DETAILED DESCRIPTION OF THE INVENTION

In the following exposition, the term “substantially optically clear” is used to describe any material that is suitable for use in the printing arts and has a substantially transparent quality. Material compositions of such commercially available films may include, for example, high-density polyethylene (HDPE), low-density polyethylene (LDPE), polyethylene terephthalate (PET), polypropylene (PP), polystyrene (PS), and polyvinyl chloride (PVC). All such compositions are considered to be polymeric film materials and are synonymous therewith.

Referring to the drawing, thereshown is a schematic diagram of an exemplary and preferred embodiment of a method 10 of creating lenticular material having a selected orientation. Method 10 includes a resin hopper 100 that is designed to hold a supply of resin R. Resin R may be, for example, any commercially available resin selected from the aforementioned HDPE, LDPE, PET, PP, PS, and PVC materials. Method 10 further includes a feed screw 110 for receiving resin R from hopper 100, one or more heaters 120 for heating and substantially melting resin R, a die 130 for delivering substantially melted resin R to a lenticularly patterned surface device 140, an abutting surface device 150 which selectively abuts device 140, optional first and second carrier surface devices 160a and 160b, and an optional turning device 170.

Turning, now, to operation of method 10, resin R from hopper 100 is gravity-fed to feed screw 110. Screw 110 transports resin R (from left to right in the drawing) to heaters 120 for heating and substantially melting resin R. In an exemplary embodiment, resin R is heated to about 500° F. to provide substantial melting and make resin R flowable or malleable. The selected melting temperature of heaters 120 is dependent, of course, upon a particular resin R selected.

Substantially melted resin R then flows downstream to die 130, whereupon it is delivered to lenticularly patterned surface device 140.

Lenticularly patterned surface device 140 acts to form lenticules L in resin R as will be further described. As used herein, the term “device” may include any suitable equipment such as a roller, plate, or some other forming means to impart a desired shape or texture to substantially melted resin R. Lenticularly patterned surface device 140 preferably embodies a roller having a cylindrical axis C and a selected number of channels 142. Channels 142 impart the desired lenticular shape in the formation of lenticules L in resin R, in cooperation with abutting surface device 150. Again, although depicted as cylindrical rollers, devices 140 and 150 may in combination comprise any suitable flatbed or rotary embossing die techniques.

Specifically, as resin R is forcibly rolled out between abutting devices 140 and 150, lenticules L are formed therein resulting in a web of lenticular material 180 containing lenticules L as will be further described.

Devices 140 and 150 may be adjusted to selectively abut one another, by way of a mechanical adjustment mechanism (not illustrated) which acts to linearly increase or decrease distance between axes C of devices 140 and 150. In this manner, a resulting thickness of material 180 may be controlled, as desired.

Also, at least one of devices 140 and 150 is preferably capable of being controlled in temperature (not illustrated) such that resin R is cooled thereby to a substantially solid and optically clear state. In the aforesaid exemplary embodiment, with heaters 120 raising resin R to a sufficiently high temperature (e.g., about 500° F.) the selective control of temperature of device 140 and/or 150 results in a cooling of resulting lenticularized material 180 to a substantially solid and optically clear state.

Material 180 then passes through optional first and second carrier surface devices 160a and 160b, and an optional turning device 170, resulting in a finished output lenticular material web 180.

Lenticular material web 180 may be characterized by a major lengthwise machine direction reference axis M and a minor transverse reference axis T. Axis M, as known to those in the art, corresponds to a machine direction of a typical printing and/or converting press. Axis T is defined as being substantially perpendicular to axis M.

It is to be particularly appreciated and understood that channels 142 of device 140 may be oriented in any selected direction or pattern relative to cylindrical axis C of device 140, and machine direction reference axis M and transverse reference axis T of web 180. Accordingly, lenticules L formed in lenticular material web 180 may be oriented in any selected direction (preferably, for wipe-on label applications, in a direction perpendicular to axis M and parallel with axis T).

Lenticular material web 180 may then be provided in a supply roll to, for example, a customer's in-line or “roll-to-roll” printing and converting process (not illustrated) for efficient production of lenticular pressure-sensitive label products. The production of such pressure-sensitive label products could include laminating, “marrying”, or otherwise joining web 180 with an interlaced image web relative to lenticules L, to produce an image having a visual illusion. Alternatively, interlaced images could be directly printed on an oppositely corresponding surface of web 180 to lenticules L.

The lenticular label products may then be provided, in turn, to an end manufacturer's “wipe-on” pressure-sensitive label application equipment.

While the present invention has been particularly shown and described with reference to the accompanying figures, it will be understood, however, that other modifications thereto are of course possible, all of which are intended to be within the true spirit and scope of the present invention. It should be appreciated that components of the invention aforedescribed may be substituted for other suitable components for achieving desired similar results, or that various accessories may be added thereto.

For example, in the exemplary method 10 and as mentioned above with reference to the drawing, device 140 may be capable of forming lenticules L in any orientation or pattern; such an orientation could be, for example, diagonal to machine direction reference axis M. Further, such a selected pattern could be a “bulls eye” or concentrically circular pattern, for fabrication of a lenticular lens material that has a property of visual magnification or enlargement of an area being viewed therethrough.

Also, interlaced images could be printed directly on a bottom surface of web 180 as discussed, and then laminated to a plain or non-printed pressure-sensitive base web. Of course, with interlaced images printed directly on the bottom surface of web 180, the base web could even be omitted entirely.

It is to be understood, then, that any suitable alternatives may be employed to provide the method of creating lenticular material having a selected orientation, of the present invention.

Lastly, the choice, of course, of compositions, sizes, and strengths of various aforementioned components of the method are all a matter of design choice depending upon intended uses of the present invention.

Accordingly, these and other various changes or modifications in form and detail of the present invention may also be made therein, again without departing from the true spirit and scope of the invention as defined by the appended claims.

1. A method of creating lenticular material having a selected orientation, comprising the steps of:
providing a substantially melted resin;
providing at least one lenticularly patterned surface device; and
providing at least one abutting surface device, to selectively abut said lenticularly patterned surface device,
wherein (i) at least one of said (a) at least one lenticularly patterned surface device and said (b) at least one abutting surface device, is chilled, and (ii) said substantially melted resin is directed between said at least one lenticularly patterned surface device and said at least one abutting surface device, whereupon said substantially melted resin is cooled to a substantially solid and optically clear state, and thereby creates at least one lenticule in a web of lenticular material having a selected orientation other than parallel to a machine direction.

2. The invention as claimed in claim 1, further comprising:
joining said web of lenticular material with an interlaced image web corresponding to said at least one lenticule, to produce an image having a visual illusion.

3. The invention as claimed in claim 1, further comprising:
printing at least one interlaced image on a surface of said web of lenticular material opposite said at least one lenticule and corresponding thereto, to produce an image having a visual illusion.
